(19) United States
(12) Patent Application Publication
(10) Pub. No.: US 2008/0223656 A1
(43) Pub. Date: Sep. 18, 2008

(54) Self-deploying automatic inflatable fire escape (SAFE)

(76) Inventor: Erwin Roy John, New York, NY (US)

Correspondence Address: Erwin Roy John, 1010 Orienta Avenue, Mamaroneck, NY, 10543, US

(21) Appl. No.: 11/717,106

(22) Filed: Mar. 13, 2007

(51) Int. Cl. A62B 1/20

(52) U.S. Cl. 182/48

(57) ABSTRACT

This invention provides a reliable means for rapid escape from a burning building when usual exits are dangerous, deploying a safe exit quickly and without requiring the child or adult user to possess unusual presence of mind, strength, manual dexterity or mechanical ability to deploy the apparatus, trained coordination or physic agility to descend. The Self-deploying Automatic inflatable Fire Escape (SAFE) is a building component containing a compressed and folded slide that is installed into an edifice during construction as an integral part of a window casement or wall, or is retrofitted under a pre-existing window, and is automatically deployed by equipment which detects a dangerous condition, sounds and alarm, notifies emergency organizations by a dial-up, opens an aperture in the wall and extends the slide by opening a valve and releasing compressed gas into an inflatable volume which is distended to become a walled chute to the ground.

### BACKGROUND

It is highly desirable to provide a safe, reliable and rapid means to escape from any room in a burning house when flames prevent or make dangerous exit via hallways and stairs. A number of solutions to this problem have been proposed and patented. U.S. Pat. No. 220036 describes an inflatable slide for attachment to a house window, which is secured to the wall of the house having a window located above the ground level. U.S. Pat. No. 4,444,290 describes an inflatable funnel of fabric connected by a bracket secured to the inside of a building into which a person jumps to slide below the window. U.S. Pat. No. 4,606,431 describes an inflatable slide that can be deployed from landing to landing in a stairwell. All of these proposed solutions are attachments to the inside or out outside of a structure. None of them provide an automatic means of making the escape apparatus immediately and locally available in an emergency.

### SUMMARY

The self-deploying automatic inflatable fire escape (SAFE) is a building component that is enclosed in a) a separate compartment which can be installed immediately under an independent window casement or b) the lower section of a panel fabricated integrally with an upper portion which is an ordinary window that may or may not be capable of being opened by the occupants of the room or c) a wall section extending from floor to ceiling of a room or space in an edifice. SAFE is intended primarily for use in a two-story dwelling and can either be installed as the building is constructed or inserted into an existing wall to replace a conventional window by a means for escape from the enclosed space of a room. It might also just be inserted into a wall below an existing window frame, with the top of the SAFE enclosure inserted below the existing window sill. When Safe is intended for use in room located on the third or fourth floor of a dwelling or business edifice, it will be contained in a wall panel extending from floor to ceiling of the room. The invention becomes an integral part of the structure, is always available and deploys automatically when a fire emergency occurs.

The example described in detail below is intended to be inserted into the wall under, or to incorporated as an integral part of, a window casement for use in a room on the second floor, with its vertical dimension comprised of a set of panels with overall length calculated to accommodate an escape slide allowing occupants of the room to reach the ground from the usual height of the second floor of the private house or apartment building. SAFE installations intended for higher floors will utilize the same design principles but the vertical dimension will reach from floor to ceiling and will have a width sufficient to accommodate the enfolded or compressed length of the Escape Slide enclosed therein. The length of the panels of which the slide is composed will be proportionately greater, and might for example be approximately 60 inches per panel for a third floor room and 90 inches per panel for a fourth floor room to reach the ground from their usual height.

SAFE can be described as a rectangular enclosure or box which can be made of variable width to conform to the type of window in the structure into which it will be placed. The box contains a tank of compressed nitrogen (or other non-flammable gas, but not oxygen), a distribution manifold connecting the tank to the escape slide, a deploying system mechanism comprised of two pistons inside a sealed cylinder constructed and positioned so that expansion of the compressed gas when the deployment system is activated, by detection of heat by the smoke alarm indicating a probable conflagration in or near the room, extends the pistons thereby pushing the inner wall into the room and the outer wall to the outside of the structure, and inflates the escape slide to allow it to fall to the ground, appropriate hinges with means on top and sides to permit the box to open its inner wall to the room, its outer wall to the outside, and the slide to deploy down to the ground. The Escape Pack Container is connected with the circuitry of a battery powered smoke detector which when activated sounds an alarm and activates a time delay relay which after a brief delay period to avoid “false alarms” closes a circuit to deliver current sufficient to melt a fusible plug in the manifold which, when melted, activates the deploying system which removes the inner wall, opens the outer wall and arms the inflation of the slide by the tank, and also contains the inflatable escape slide itself, made of flexible fabric or plastic impermeable to gas (such as used, for instance, in inflatable boats) or made of metal. Provision is made for manual deployment of the slide in the eventuality of failure of the automatic deployment system or circuitry, as well as for a manual over-ride to abort the deployment during the delay period, in the case of a “false alarm”. Full details of these various constituents of the SAFE system are described in separate sections that follow, accompanied by the illustrative FIGS. 1-6.

### BRIEF DESCRIPTION OF THE DRAWINGS

Escape Pack Container—FIG. 1

As an example for the second floor, as shown in a front view in FIG. 1, the Escape Pack Container of SAFE is a box, anchored to the room wall (1-1) and inserted below the casement of a window (1-2), that would be, for example, 36 inches from left to right side (dimension X), 8 inches wide (dimension Y), and 30 inches high (Z). The box is made of steel, with the inside and outside panels in the XY-plane painted, veneered, plastered or otherwise covered in a manner to correspond and harmonize with the inside wall of the room and the outside wall of the structure into which it is placed, in an attractive and unobstrusive way. The top of the box, the YZ-plane, either constitutes or is attached to the usual sill of the window space in the structure. At the level of the room floor (1-3), the bottom of the box is anchored (1-4) to the structural framework of the building wall. The junctions between the bottom of the box in the YZ-plane and both the inside and outside walls of the box in the XY-plane are hinged for its full width. Inside the Escape Pack Container is a folded Escape Slide (1-5) which bears a crossbar stiffener (1-6) of metal or some strong material and a Tank (1-7) containing compressed air or an inert gas such as nitrogen. Further details of the contents of the Escape Pack Container are provided in subsequent sections of this Application.

Contents of the Escape Pack Container—FIG. 2

FIG. 2 presents a cut-away view from the side (2-1) of the Escape Pack Container, depicted as a transparent rendering, which comprises an integral part of a window and window casement (2-2) or is inserted into the wall below the window sill (2-3), as installed in the wall so that the outside boundary of the container is the outer wall (2-4) of the edifice and the inside boundary of the container is the inside wall of the room (2-5). The Escape Slide may be so configured that the outer wall of the room comprises the first panel of the slide when it deploys while the inner wall may remain in the room or the slide may be so configures as to carry the inner wall of the room with it as a base of the Landing Pad at the bottom or last panel of the slide.

The wall is assumed to be at least 8 inches or more in thickness, for example, but the thickness of the container would be adjusted in various models to correspond to the dimensions of the building wall. The bottom of the Escape Pack Container accommodates a cylindrical tank (2-6) containing compressed air or a non-inflammable gas such as nitrogen. Inside the Escape Pack Container are folded the multiple folded panels and landing pad (2-7) before deployment of the inflatable escape slide of SAFE, reinforcement stiffeners (2-8) that cross each panel from side to side to provide rigidity and prevent the slide from sagging when bearing weight and a deployment mechanism, each of which will be described and illustrated below in further detail. The Labels Panel 1 to Panel 7 in 2-1 denote the successive folded panels of the slide, but must be understood as an example, since the Escape Slide may have N panels in various implementations to accommodate variations in vertical distance from the ground to the floor of the room in the edifice in which SAFE is installed. Further details of these components of SAFE are provided below and illustrated in subsequent Figures.

Compressed Gas Cylinder

As shown in FIG. 3, the Escape Pack Container encloses a compressed gas cylinder (3-1) here described more fully, together with its control system and output manifold. This tank, for example about 34 inches long with a diameter of 7.5 inches comprising a volume of 1500 cubic inches, contains the gas which when expanded will inflate the Escape Slide. The slide, to be further described below, has a cross section of 280 square inches and a length of 300 inches (25 feet will reach the ground from the floor of the second story room 15 feet above the ground at an angle of 45 degrees). Thus, the interior volume of the side when inflated is about 84000 cubic inches. The pressure of one atmosphere if the slide were inflated to fully distend this volume would be about 15 psi. Accordingly, the gas in the tank must be pressurized at about 56 times atmospheric to expand to fill the slide at atmospheric pressure of 15 psi. In order to achieve an inflated pressure of 30 psi, estimated as sufficient to extend the slide and provide adequate rigidity, the gas must be compressed to 112 times atmospheric, or 1680 psi. A cylinder with 10 inch diameter has a volume of 2669 cubic inches, and would require pressurization at 62 times atmospheric or about 930 psig to fill the slide. Thus, SAFE can be fabricated with an eight inch cylinder pressurized at 2000 psig or a 10 inch cylinder pressurized at 1000 psig. It is not clear a pressure of 2000 psig is practicable, so it may be necessary to provide a tank 10 inches in diameter and a consequent enlargement of the space provided in the Escape Pack Container.

Gas Cylinder, Distribution Manifold, Automatic Deployment System, Deployed Slide and System Controller—FIG. 3

FIG. 3 depicts the compressed gas cylinder (3-1) which is located at the bottom of the container, the manifold (3-2) that, through a high pressure valve with an outflow blocked by a fusible valve (3-6), connects the cylinder to inflate the Escape Slide (3-3), shown as if deployed to depict the relation between the parts of the system, the deployment pistons assembly (3-4) or other mechanism that, when the system deploys, displace and position the inner and outer walls of the Escape Pack Container sections that comprise an integral part of the inner and outer walls of the room, all stored compactly within the Escape Pack Container. Outside the Escape Pack Container and mounted conveniently and unobtrusively within the room or space is the Automatic Deployment System Controller (3-5).

The Automatic Deployment System Controller, schematically identified in FIG. 3 as component (3-5), is comprised of apparatus senses the probable presence of a conflagration or other dangerous condition in the vicinity of or within the space of the room. This controller will operate as described in detail in what follows and when activated 1) will sound an alarm and deploy the Escape Slide, and also 2) will automatically activate a telephone dial-up or other notification to emergency facilities of the community within which the edifice is located. The automatic Deployment System Controller (3-5) is comprised of a strightforward circuit containing elements whose relationship and functions have been described in the following paragraph as a) to g), which is therefore considered unnecessary to illustrate here in graphic detail but encompasses a) a conventional battery powered smoke detector connected in parallel to b) an auditory alarm signal, that will be triggered by a rise in the ambient temperature above some critical temperature, for example 120 degrees F., or by detection of a significant amount of smoke or some dangerous condition in the ambient room air or the vicinity of or within the space of the room, that persists for a “confirmation grace period”, for example, more than 5 minutes after the alarm sounds, as measured by c) a delay timer triggered by that event. When the post-alarm confirmation grace period expires, unless the “Manual Disarm SAFE” function described below[0010-C] has been activated, the timer closes d) an automatic arming switch that delivers current from the building electrical power source connected in parallel with e) a rechargeable battery power supply in the controller system, that is always kept charged by f) a transformer-charging circuit connected to the 110-220 Volt or other electrical power system of the dwelling, sufficient to melt the fusible valve (3-6) and deploy the Escape Slide as described in [0010-A] below. This circuit design is intended to ensure that SAFE will always deploy when a fire threatens the room occupants, even if the power to the dwelling were to be interrupted by conflagration. However, it is recognized that the smoke detector may fail to activate the system in the presence of a dangerous situation or, conversely, may erroneously activate falsely detecting and notifying in a situation which is actually a “false alarm”. In that event, manual activation of the circuit melting the fusible valve can also be accomplished by depressing g) a wall mounted manual arming switch or other Emergency Deployment Control as summarized in [0010-B].

A—Automatic Arming of the Deployment System of SAFE

When activated, the Automatic Deployment System delivers sufficient current to a fusible plug (3-6), that normally retains the gas in the cylinder by blocking the exit valve from the cylinder, and the melting of the fusible valve allows the compressed gas to expand into the inflatable panels and side walls of the Escape slide (3-3), thereby extending it outside the building and deploying it to the ground.

B—Manual Arming of the Deployment System of SAFE

In the unlikely event that the smoke detector has failed, the circuit includes a Standby Backup Deployment capability that consists of a switch conveniently mounted which when closed will send current from the house electrical system or, if house power has been interrupted or lost, from the charged battery to melt the Fusible Plug (3-6). If house power has been lost and the standby battery is not sufficiently charged to melt the Fusible Plug, so that the Standby Backup provision is disabled, a Manual Fusible Valve Removal Assembly can be actuated by pulling a cable (not illustrated) that has been provided with a handle or lever in the vicinity of the Escape Pack Container or built into it, which is attached to the fusible valve and when thereby physically removing or otherwise dislodging the fusible valve, directly arming the release of the compressed gas to deploy SAFE.

C—Manual Disarming of SAFE

It must be recognized that smoke detector systems not only sometimes malfunction and fail to activate an alarm in the presence of a conflagration or smoke in the air, but sometimes conversely activate to give a false alarm because of a transient perturbation of power or a flareup, for example, of bacon in a frying pan. In order to prevent inadvertent deployment of safe in a “false alarm” situation, means must be provided to disable the arming system, to interrupt the circuit that would deliver current to melt the fusible valve or plug, and to turn off the alarm. Such means might be a keypad with a simple code or a switch clearly marked, for example, “turn off alarm and disable SAFE system”, mounted on the wall next to the smoke alarm or next to the window above the escape pack container. The “Disarm” instruction must be delivered within the “confirmation grace period” provided by the sustained sounding of the alarm for the period set by the timer 3-5.

Construction of the Folded Deflated and Inflated Escape Slide—FIG. 4

FIG. 4-1 depicts a cross-section through a typical folded panel of the Escape Slide, and in various applications the Escape Slide will be comprised of N such panels, and in this example there will be 7 such panels plus a Landing Cushion Pad. From top to bottom in the deflated cross-section (4-1) are shown: the infolded, deflated and collapsed double layers of the side walls (cross-hatched) on each side of the slide panel, formed of heavy gauge PVC or rubberized fabric impermeable to gas such as, for example, the fabrics from which inflatable boats are constructed. The side wall of each folded panel when the escape Slide is deployed and inflated (4-2) will be rectangular, about 4 inches thick and 10 inches high by 34 inches long. Below the folded side walls lies the deflated bottom pad of the panel which consists of a double layer of the same PVC tubing enclosing a volume continuous with the side walls. Note that each of the side panels are affixed by some method of bonding, welding, cementing or stitching across their entire bottom surface 4 inches wide by 34 inches long at each side of the panel to the length-wise 30 inch wide by 34 inches long section that comprises a bottom pad of each panel. Under this bottom pad are located and cemented or otherwise bonded to the underside layer of material comprising the Escape Slide are stiffener crossbars (4-3) that reinforce the panel from side to side, formed of a flat panel or bar of metal, plastic, ceramic or other material with adequate strength and width to provide sufficient rigidity to prevent sagging, infolding or collapse when bearing the weight of an adult person descending in the Escape Slide.

The continuous interior volume enclosed within the double walls of each of the side panels and the bottom compartment across the N panels of the Escape Slide, when inflated and deployed (4-2) with an adequate internal pressure by the gas entering from the cylinder via the manifold, will a) vertically dilate and extend to become rectangular tubes retaining walls serving as retaining walls with for example a 10 inch high by 4 inch cross-section and approximately 30-34 inch long on each side of each panel and extending the full length of Escape Slide spanning the N panels and by inflate a 2 inch thick approximately 24-34 inches wide by 30-34 inches long cushioning section at the bottom of each panel with its upper surface coated with a substance to lower its friction so that it will be slippery (4-4).

The internal spaces of the two sides and the bottoms of the N panels, although separate from one another, are contiguous from panel to panel and form three volumes which are continuous across the length of the entire slide. Their inflation thus expands the sides to become rigid tubes and thrusts out the overall length of the Escape Slide to form a continuous rigid chute-shaped, walled tube with a slick bottom cushioned surface across all the N panels of the slide, ending in a “landing pad”. The release of gas when the fusible valve no longer obstructs the outflow from the cylinder also activates the piston deployment system at the same time, displacing the outer wall of the container, which becomes the first panel of the Escape Slide.

Further Construction Details of Escape Slide, Top View Deployed—FIG. 5

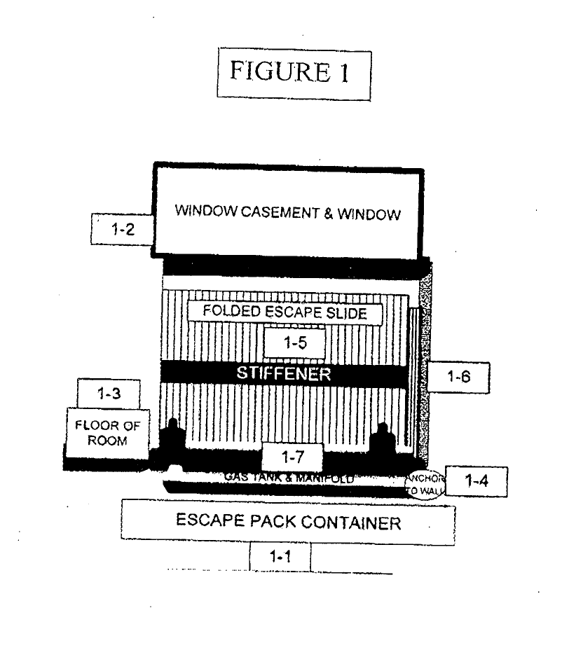

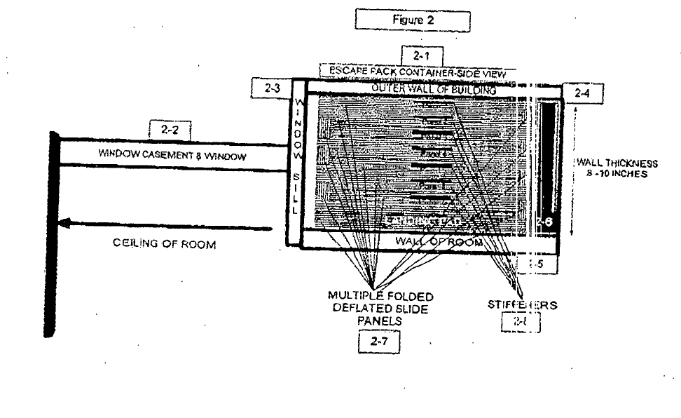

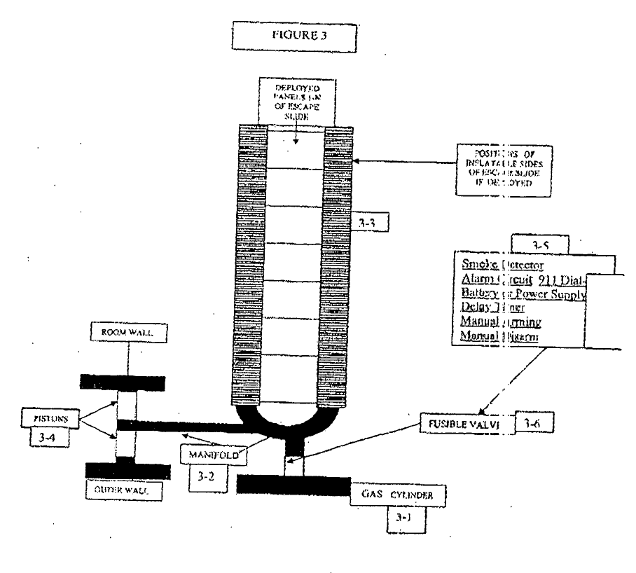

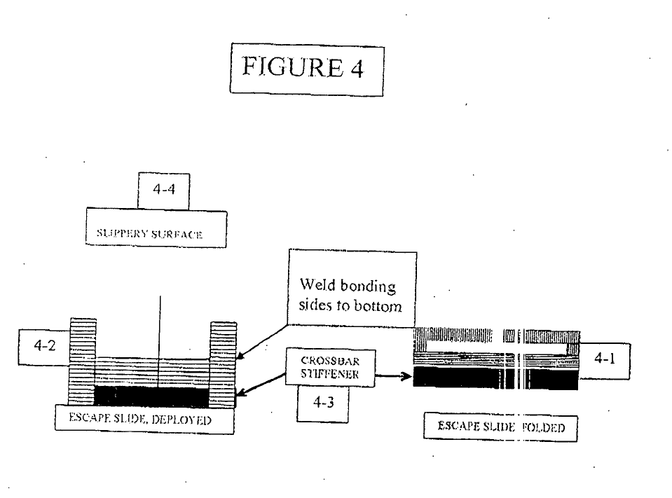

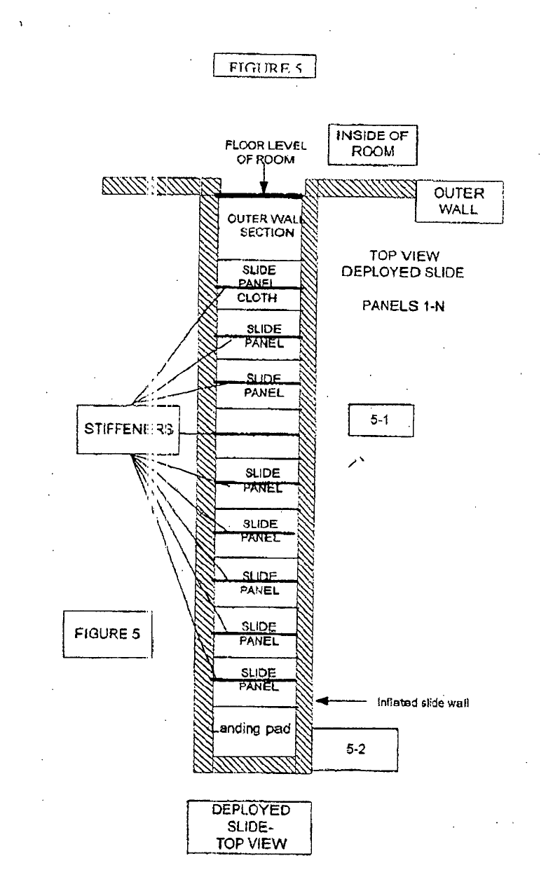

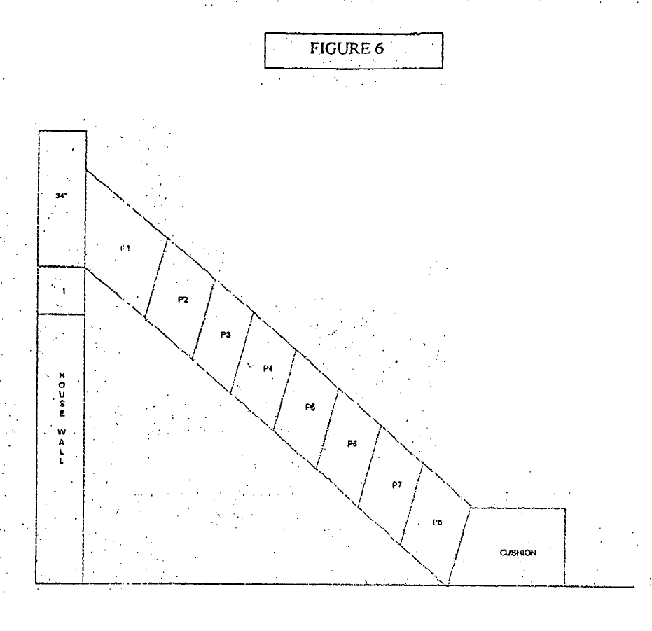

The folded escape slide in the Escape Pack Container is further illustrated deployed in FIG. 5, which depicts a top view (5-1) of N panels of the escape slide fully deployed, showing that it is anchored at the top to the wall of the house at the level of the floor. Panel 1 of the Escape Slide is the outer wall section of the Escape Pack Container, which previous to deployment served as the outer wall of the house. Panels 2-N are exactly like the panels depicted in FIGS. 2, 3, and 4. Panel N at the bottom is a thick, cushioned “landing pad” to soften the impact when the person reaches the bottom of the slide into which he/she jumped when exiting the room. The cross-hatched side sections of the slide represent the inflated sides of each panel, which are interconnected to form a continuous vertical volume that becomes the sides constituting a retaining wall to the chute formed by the inflated side members of the Escape Slide, previously shown in FIG. 4 in their folded (4-1) or deployed (4-2) positions, so that the escaping individuals cannot fall off the side of the slide while descending safely to the ground. The stiffeners comprised of flat panels of ceramic, metal or plastic are depicted, below and extending across the width of each panel to prevent the slide from sagging under the weight of escaping individuals.

Escape Slide Side View, Deployed—FIG. 6

FIG. 6 presents a side view of the inflated slide, extending from the wall of the house. As an example, it is assumed that the floor of the second floor room from which the person is exiting is 15 feet above the ground and there are 7 panels each 34 inches long. Fully extended when deployed, this gives an overall length of almost exactly 20 feet. At an angle of 45 degrees, to enable smooth descent along the slide, the length from the outer wall of the room 15 feet above to the ground would be 21 feet. Ideally, at this angle the N-1th panel of the deployed SAFE escape slide will reach the ground about 12-15 feet from the exterior wall of the house, and the Nth panel will inflate enough to provide a landing pad sufficiently resilient to cushion the impact of a person reaching the

What is claimed is:

1. An escape slide or other means, for example an enclosure or other device, which is located under a window or as a panel in the wall to enable rapid egress from a room or space in a building in which there is a dangerous condition, such as a fire, and which may automatically detect the dangerous condition and thereby be activated or be manually activated and which contains a deflated or folded or otherwise stored chute, slide or ladder which can be automatically inflated or unfolded or otherwise deployed or manually extended in some convenient way in the case of an emergency to provide a safe and easy method to descend from the edifice to the ground.

2. A means to provide egress from a space inside an edifice in a safe and convenient way by a system characterized by
a) the incorporation of the assembly as an integral building component, such as for example,
b) enclosing the Escape Slide in an Escape Pack Container inserted under an existing window, or
c) fabricated into a window casement built into an opening provided in the wall of the building and harmonious with the design of other windows, or
d) incorporated as a floor to ceiling section of a wall of a room or other space inside a building; with provision for
e) the automatic deployment of the Escape Slide by actuation of a Deployment System internal to the Escape Pack Container preferably
f) but not uniquely powered by compressed gases pressurized in a container enclosed in then Escape Pack Container;
g) activated automatically by
h) a circuit serving as an Automatic Deployment Controller which
i) monitors the environment using for example a smoke or temperature detector which when activated by environmental conditions signaling a hazard
j) sounds an alarm,
k) offers a cancellation grace period before deploying the Escape Slide and means to disable the system in the case of a “false alarm”, and
l) after the grace period elapses,
m) activates an automatic dial up or otherwise notifies local and community emergency services, and
n) inflates or otherwise deploys an escape slide which is expelled from the edifice and provides a safe means of egress and descent to the ground.

3. A Self-deploying Automatic Fire Escape, “SAFE”, comprised of an Escape Pack Container that can be installed as a compartment under an existing window or constructed as an integral part resting in the lower section of a window casement under the section containing transparent panes, so that its inner wall constitutes part of the wall of the room and the outer wall is the outside wall of the dwelling within which the room is located, and containing
a. an inflatable Escape Slide with sides and a slippery, low friction bottom inner surface of the slide constructed of a flexible material such as PVC or rubberized fabric of sufficient thickness to contain an internal pressure of 2-3 atmosphere, and comprised of
b. three tubular volumes of which two have a rectangular or oval cross-section each of which when inflated establish a continuous wall that serves as the two side retaining walls of the slide and which are each bonded or in some fashion securely fastened to a third volume which serves as the bottom of the slide and when inflated provides a cushioned and slippery, low friction surface reaching to the ground, and which are
c. normally retained and stored un-inflated and collapsed in accordion fashion inside an Escape Pack Container, mounted in a window casement or other section of the outer wall of the dwelling, which also contains
d. a cylinder containing compressed gases and a manifold connected through a high pressure valve to a fusible valve, obstructing
e. the input to the inflatable escape slide tubing and a space within the cylinders of a gas-tight assembly containing two pistons oriented horizontally 180 degrees apart and
f. constructed so that when activated by expanding gas, the pistons extend and push laterally against the inner and outer walls of the Escape Pack Container to detach the inner wall and open the outer wall and
g. provide an opening in the outer wall of the edifice, and enabling access to
h. the escape slide, which at the same time is pushed outside the dwelling, deployed and inflated by the expanding gases, and which
i. deploys to provide a chute reaching from the floor of the room to the ground and falling by the force of gravity to the ground level, configured with inflated sides and bottom and a cushion landing pad when inflated, and
j. providing automatic means to melt the fusible valve and allow the compressed gas inside the pressurized cylinder to expand and deploy the Escape Slide, such means comprised of
k. a deployment control system, containing
l. a smoke and heat detector which will be activated, when ambient conditions indicate the probable occurrence of a conflagration inside or nearby to the window casement or wall panel in which SAFE is installed, and
m. will sound a local fire alarm and contact 911 to report an emergency, and
n. will activate a delay timer and relay which, if the condition persists for longer than a preset time interval, will
o. close a switch in a circuit to deliver electric current sufficient to melt the fusible valve, with
p. the required current provided by a rechargeable battery pack or other power supply always kept fully charged by connection to an appropriate transformer connected to the electric system of the edifice, but
q. if the automatic means fails for any reason to ensure deployment, providing a push button or other means for manual closure of the electrical circuit to melt the fusible valve, but in the event that the source of electrical power from the edifice has failed,
r. providing a physical connection to the fusible valve or plug in the gas outlet of the manifold for dislodging the plug by manually pulling it out of the manifold into a recess in the manifold designed for that purpose, and
s. if the smoke and heat detector or alarm is activated under circumstances in which the conditions in the room or the source of heat and/or smoke is not considered to be dangerous, also provides an easily accessible means such as a keypad or switch that when actuated will over-ride and disarm the automatic deployment system.

4. A means such as described in claim 3 for safe egress from room or space in a either a residential dwelling or commercial edifice.

5. A means such as described in claim 3 for safe egress from the second or any higher floor of the edifice.

6. A means such as described in claim 3 which consists of a wall panel expanding from floor to ceiling to provide safe egress from a room or other space inside an edifice.

7. A means such as described in claim 3a, but where the Escape Slide is comprised of two inflatable tubes made of PVC or some fabric impermeable by gas that are bonded to each side of the two edges of a sufficient number of panels wide enough to accommodate an adult person and long enough in aggregate to reach the ground.

8. The embodiment of claim 7, in which, for example, these tubes have a rectangular or oval cross section that is approximately 5 inches wide by 10 inches high and are 22 feet (264 inches) long or longer, with the 5 inch wide by 264 inch long or other area on the bottom of each tube bonded by an appropriate cement to a set of N slides or panels, so that when folded in accordion style the compressed tube-panel assembly can be placed in the Escape Pack Container and connected to the gas manifold, but when deployed the inflated tubes provide a rigid wall, extending the N panels to make a continuous slide with tubular sides and a slippery or low friction surface on the inside on the bottom of the slide to allow a person to slide safely to the ground.

9. A means such as described in claim 8, but where the Escape Slide is comprised of N, for example eight or more, sheets or panels, for example, each 24 to 30 inch wide and 24 to 30 inches or more in length, made of interlocking plates or panels of metal such as aluminum or steel or fabricated of polyvinyl chloride or some non-inflammable plastic, and telescoped into an interlocking set that will fit into the Escape Pack Container located in a window casement or a wall panel and that when extended are 22 feet or more in length, and in which two inflatable tube 5 inches by 12 inches in cross-section are connected to the gas manifold as in claim 2c as well as cemented to the sides of the bottom panel, which is the outermost of the nested, telescoped set of panels, so that when deployed the inflated tubes together with the interlocking panels provide a rigid wall on each side of the extended and interlocked panels and a rigid supporting slide surface, with the inflated tubes extending the eight or N panels to make a continuous slide that reaches the ground.

10. A means such as described in claim 8, where the Escape Pack Container is as described above, but contains a coiled ladder sufficiently long to reach the ground from the second, third or higher floor, comprised of ropes of fiber or metal links of chain constituting the vertical sides and 2-3 inch slats of 3-3 inch aluminum comprising the rungs, with each rung preferably carrying a prong or peg about four inches long that protrudes toward the wall when the ladder is deployed to hold the rungs away from the wall to allow easy placement of the feet as a person descends.

11. A means such as described in claim 8, where the Escape Pack Container is as described above but, instead of an inflatable tubing or tubing-metal combination, contains a set of eight or more panels constructed of aluminum sheets ⅜ thick×24 inches wide×34 inches long (or as long as the floor to ceiling height of the room, interlocking with each other so as to constitute a continuous surface when deployed, a fabricated such that the panels slide into one another like a flat telescope in order to fit inside the Escape Pack Container, and replace the sides and bottom of the inflatable SAFE escape slide by a rigid non-inflammable surface, and the sides of the panels are configured to comprise interlocking channels shaped like a vertically stretched letters “C”, 6 inches high by 2 inches wide and extending along the 34 inch or greater length of each panel, configured so that the sides of successive panels fit inside one another when telescoped but when extended interlock to provide and comprise a side wall six inches high and 2 inches wide, with the sides interlocked via the “C” channels of similarly intended configuration to provide sufficient strength so that the slide thus configured has rigidity capable of bearing the weight of an adult person sliding down the chute.

12. The metal slide described in claim 8, normally telescoped when stored in the Escape Pack Container, which is deployed to become a chute when the arming system similar to that described in claim 2 inflates two pneumatic fabric tubes for example four inches in diameter when inflated, that are cemented to the edge of the panels that will become the bottom of the slide when deployed, and when inflated force the interlocked telescoping panels to slide along one another and extend, falling to the ground to become a continuous slide.

13. A means such as described in claim 8, where the Escape Pack Container is as described above, but contains a set of eight or N panels constructed of aluminum sheets ⅜ thick×24 inches wide×34 inch long, hinged to each other so as to constitute a continuous surface when deployed, such that these panels become the bottom of the SAFE escape slide when extended, but when not deployed the panels fold into one another like an accordion in order to fit inside the Escape Pack Container.

14. A means such as described in claim 3, but in which an array of Escape Pack Containers are located at selected places in multiple rooms of a residential edifice or commercial building interconnected to a central tank of non-flammable compressed gases by a network of tubing or pipes and with valves controlling release of the gas access into the tubing or pipe manifold activated by a central alarm system that may deploy all Escape Slides automatically, a control panel or provision of local switching that allows selection of particular spaces in the edifice from which the escape slides should be deployed or actuates deployment of all escape slides in the edifice, means for manual deployment of any or all such slides, and means to inform personnel of fire or police departments or other emergency response personnel to enable discretionary deployment of any or all escape slides installed in the building.

15. A means such as described in claim 3 but where the pistons and chamber described in 3d and 3e are replaced by a mechanical system of levers or other means to allow access to the Escape Slide.

16. A means such as described in claim 3 but where the fusible plug and the means to melt it are replaced by a rotary valve controlled by a handle preventing release and delivery of compressed gases that is normally closed but the handle of which can be pulled or rotated and opened by a solenoid valve controller activated by electrical current delivered either from a battery pack or from the electrical system provided current to the edifice.

17. A means such as described in claim 3 but where the fusible valve is replaced by a rotary valve opened by a screw rotated by a rotary solenoid.

18. A system such as described in claim 3 but where the automatic alarm and actuating mechanism is replaced by a lever located next to the window casement which when pulled actuates the withdrawal of the plug or other obstacle preventing escape of gas from the cylinder and inflation of the escape slide or achieving manually controlled deployment of the other escape means described above.

19. A means such as described in claim 3, but in which the system described is replaced by a portable Self-deploying Automatic Fire Escape, “SAFE”, comprised of and enclosed within an Escape Pack Container which is a fire-proof, latched box like a large suitcase approximately 30 to 34 inches wide, 8 inches deep and 36 inches high that can be stored under a bed or in a closet, containing either an inflatable Escape Slide as described in claim 3a, or any one of the several alternative means of fabricating an Escape Slide described above that can be removed from the unlatched and opened container, means to hook or otherwise hold the top end of any such contained slide in place connected to the sill of a window in the room which has been fully opened and connects to the outside, a cylinder located inside the Escape Pack Container connected by tubes of metal, fabric or plastic to, and containing sufficient pressurized gas to adequately inflate, tubing which is a component of, carried within or comprising any of these Escape Slides, the cylinder sealed by a high pressure valve that can be turned by hand or otherwise opened to release the gas, so as to inflate the Escape Slide that has been properly secured by its upper end to the sill or edge of the opened window and placed outside the window, so that the expanding gas will deploy the inflatable elements of the slide and extend it so that it reaches the ground and provides a safe and easy way for occupants of the room to climb on the window sill, sit upon the edge and launch themselves in to the space of the slide restricted by its side walls and descend safely to the ground.
